(19) United States
(12) Patent Application Publication
(10) Pub. No.: US 2018/0293959 A1
(43) Pub. Date: Oct. 11, 2018

(54) DEVICE AND METHOD FOR DISPLAYING SYNCHRONIZED COLLAGE OF DIGITAL CONTENT IN DIGITAL PHOTO FRAMES

(71) Applicant: Rajesh MONGA, New Delhi (IN)

(72) Inventors: Rajesh MONGA, New Delhi (IN); Yashwinder SINGH, Simour (IN); Jaswinder Singh KOHLI, New Delhi (IN); Jaspreet Singh BHATIA, New Delhi (IN)

(73) Assignee: Rajesh MONGA, New Delhi (IN)

(21) Appl. No.: 15/763,624

(22) PCT Filed: Sep. 29, 2016
(86) PCT No.: PCT/IB2016/055828

§ 371 Date: Mar. 27, 2018

(30) Foreign Application Priority Data
Sep. 30, 2015 (IN) 3116/DEL/2015

(51) Int. Cl. G09G 5/12; G06F 3/14; H04N 21/43; H04N 21/472

(52) U.S. Cl. CPC G09G 5/12; G06F 3/1423; G09G 2370/02; H04N 21/47217; G09G 2380/16; H04N 21/4307

(57) ABSTRACT

A system and method for displaying a collage of content is disclosed. The system includes a network; a plurality of displays displaying same/different content or a part thereof; a master content playback device generates synchronization instructions for content display; and a plurality of slave content playback devices communicating with the master content playback device via the network, each slave content playback device is paired with a respective display, each slave content playback device applies content effects to the content. The master content playback device transmits the synchronization instructions to the slave content playback devices to playback the content with the content effects on the respective display in a synchronized manner.

### CROSS REFERENCE TO RELATED APPLICATION

This application claims the benefit of Indian Provisional Patent Application: 3116/DEL/2015, titled “DEVICE AND METHOD FOR DISPLAYING SYNCHRONIZED COLLAGE OF DIGITAL CONTENT IN DIGITAL PHOTO FRAMES” and filed on 30 Sep. 2015, the entire disclosure of which is hereby incorporated by reference herein for all purposes.

### FIELD OF TECHNOLOGY

The present invention generally relates to a device and method of displaying digital content (images, videos etc.) on any of the available digital display devices based upon pre-programmed instructions provided through a playback device connected to the display device. More particularly, the present invention provides a synchronized collage of digital photo frames where the digital content in every display is synchronized and connected with each other.

### BACKGROUND OF THE INVENTION

Generally, a digital content display device or digital photo frame is a LCD or LED display integrated with a microprocessor. The content display device might contain an integrated memory to store the digital content or a universal serial bus (USB) outlet to receive a USB based memory stick to be used as storage in which digital content is stored and read. The content display device when powered ON, displays contents present in the memory of the content display device. The microprocessor decodes the retrieved contents in order to extract necessary information which is passed on to a display driver to display the decoded content on the content display device.

The existing content display devices lack intelligence regarding the display of dynamic digital content, the transition effects to be put while displaying the content, etc. Further, if a user has to change or upload a new content, these digital content display devices are to be connected and configured to one or more computing devices such as a computer or a laptop such that the content is uploaded into the digital content display device memory. Alternatively, a USB memory stick/or various compatible memory devices such SD Card, CF Cards etc. . . . can also be used to upload the content to the digital content display device memory but there exists no further intelligence on how and/or when an uploaded digital content is to be has to be displayed with respect to another content.

### SUMMARY OF THE INVENTION

Therefore, an advanced digital content playback device is required which may select various transition effects on the content depending upon the pre-configured settings and rules. The advanced content playback device may display contents based upon the time of the day, weather conditions in the current location as well as synchronized playback of content across many such devices connected via network etc.

In an embodiment, a system for displaying a collage of content is disclosed. The system includes a network; a plurality of displays displaying same/different content or a part thereof; a master content playback device generates synchronization instructions for content display; and a plurality of slave content playback devices communicating with the master content playback device via the network, each slave content playback device is paired with a respective display, each slave content playback device applies content effects to the content; the master may also be paired with one or more display devices for displaying the content; and the master may apply content effects to the content. The master content playback device transmits the synchronization instructions to the slave content playback devices to playback the content with the content effects on the respective display in a synchronized manner.

In another embodiment, a system for creating a collage of synchronized content is disclosed. The system includes a manager module for searching for two or more content playback devices on a network, maintaining a playback group comprising of the two or more content playback devices and assigning one of the content playback devices in the playback group as a master content playback device and the remaining as slave content playback devices; a stage design module for creating a layout of the arrangement of the content playback devices within the collage to define and quantify the integral properties of the collage; a playlist generation module for creating one or more playlists of the content; and a synchronization module for assigning at least a portion of the one or more playlists of the content to each content playback device in the playback group.

In yet another embodiment, a method for creating a collage of synchronized content is disclosed. The method includes searching for two or more content playback devices on a network; maintaining a playback group comprising of the two or more content playback devices; assigning one of the content playback devices in the playback group as a master content playback device and the remaining as slave content playback devices; creating a layout of the arrangement of the content playback devices within the collage to define and quantify the integral properties of the collage; creating one or more playlists of the content; and assigning at least a portion of the one or more playlists of the content to each content playback device in the playback group.

In yet another embodiment, a method of displaying a collage of synchronized content is disclosed. The method includes decoding a content to be displayed on a display of a slave content playback device; receiving at least a portion of one or more playlists of the content; receiving one or more synchronization instructions from a master content playback device; displaying the decoded content with content effects as per the received playlist and the synchronization instructions; and controlling playback of the content with content effects on the display of the slave content playback device.

In yet another embodiment, a method of displaying a collage of synchronized content is disclosed. The method includes decoding a content to be displayed on a display of a master content playback device; receiving at least a portion of one or more playlists of the content; generating one or more synchronization instructions to be associated with the content while the content is being displayed in a synchronized manner on the display; displaying the decoded content with content effect as per the received playlist and synchronization instructions; and controlling playback of the content with the content effect on the display of the slave content playback device.

### BRIEF DESCRIPTION OF THE DRAWINGS

FIG. 1a depicts a system comprising a display device, content playback device and server for practicing the teachings in accordance with one embodiment of the present disclosure.

FIG. 1b depicts an exemplary implementation of the system of FIG. 1a.

FIG. 2 depicts an exemplary architecture illustrating connections between multiple content playback devices and server.

FIG. 3 illustrates a modular block diagram of a playback software of a content playback device in accordance with an embodiment of the present disclosure.

FIG. 4 illustrates exemplary modular block diagram of the playback server software of the server.

FIG. 5a illustrates a flow diagram depicting steps for creating a collage of synchronized digital content.

FIG. 5b illustrates a flow diagram depicting steps for displaying a collage of synchronized digital contents at the slave content playback device.

FIG. 5c illustrates a flow diagram depicting steps for displaying a collage of synchronized digital contents at the master content playback device.

FIG. 6 represents the system diagram illustrating the master broadcasting sync commands/signals for establishing synchronization between master and one or more salves.

FIG. 7 shows a flow chart for the case when master malfunctions in accordance with one embodiment of the present disclosure.

FIG. 8 depicts a time sequence diagram illustrating the availability of content playback devices.

FIG. 9a illustrates the structure of normal playlist.

FIG. 9b illustrates the structure of playlist group.

FIG. 10 illustrates a stage configured to comprise of various display devices.

### DETAILED DESCRIPTION OF THE EMBODIMENTS

The present disclosure provides a method and a system for displaying digital content with content effects on a plurality of display devices organized in a pre-defined arrangement. The digital content is displayed in a synchronized fashion or otherwise on the display devices. In an embodiment, each display device displays same or different digital content. In an alternate embodiment, each display device displays a portion of the digital content. The digital content includes without limitation a collage, artwork, photo wall, videos, images, audio, text with or without formatting, RSS content, camera input, streaming content, live data, machine capture etc. The digital content may be digital right management (DRM) protected content. The content effects includes without limitation transition effects, filters, masking, cropping, etc. The pre-defined arrangement of the display devices used to create the art wall/collage includes individual placement of the display devices at any angle/orientation. Further, the display devices can be of any shape/size. Embodiments of the present invention will now be described in detail with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements.

Applications, software programs or computer readable instructions may be referred to as components or modules. Applications may be hardwired or hard coded in hardware or take the form of software executing on a general purpose computer, such that, when the software is loaded into and/or executed by the computer, the computer becomes an apparatus for practicing the invention, or they are available via a web service. Applications may also be downloaded in whole or in part through the use of a software development kit or a toolkit that enables the creation and implementation of the present invention. In this specification, these implementations, or any other form that the invention may take, may be referred to as techniques. In general, the order of the steps of the disclosed processes may be altered within the scope of the invention.

In the forgoing description, reference to the following terms is made:

“Triggers” are events which usually disrupt the normal playback resulting in either changing the digital content or modifying the current running content as per pre-defined instructions or as per instructions received from the above said trigger. Triggers can be of external or internal types depending upon the origination of the interrupt/signal which leads to the disruption. The triggers can be generated from various sensors attached to a display device either directly or indirectly. Alternately, the triggers may be provided by third-party information providers with respect to emergency alert, date/time alert, weather alert, pollution alert, birthdays, anniversaries, festivals or any special day alert, noise alert, ambient temperature, ambient lighting alert, music alert, etc. The triggers may be automation device generated, RS232 generated, etc.

“Mask/Mat” as used in the context of the present disclosure refers to a display area inside the edge of a display device. The mask can contain information messages as well. The mats/mask can also be indicative of various encoded or otherwise information such as outside temperature, ambient noise, pollution etc.

“Synchronized” content playback as used in the context of the present disclosure refers to same/different digital content played on all content playback devices within a playback group at the same time.

“Playlist” is an ordered list of digital content, reference digital content, triggers etc. Reference digital content comprises but is not limited to the information provided by external sources like weather feed, RSS feed, etc. Further, a playlist can also be created in a fashion such that, a single digital content can be spread over the complete or partial playback group to create a single big content. In this case, each content playback device displays only a part of the whole content (like mosaic). The playlist can also be a collection of digital content created/segregated based on but not limited to themes, events, moods, occasions. Playlists can be switched, modified, altered as per users' choice via either playback server/controller/user instructions/voice commands/gestures.

“Playlist group” is a group of multiple playlists, combined to act as a single playlist. “Playlist group” is playlists inside playlist, which afterwards can be assigned to individual content playback devices within a group.

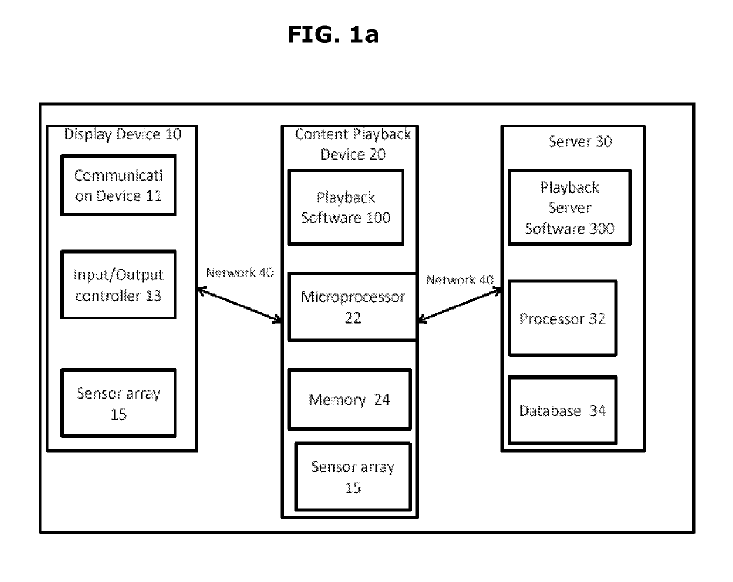

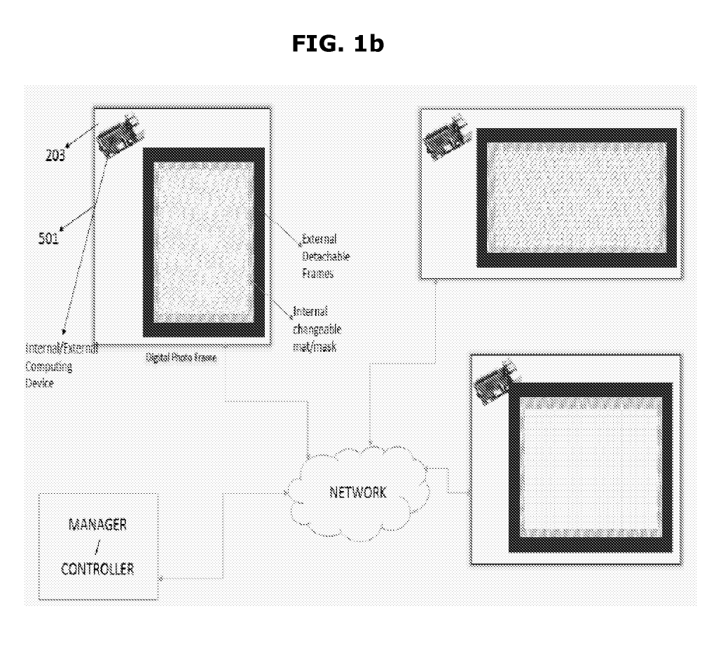

In FIG. 1 a, the system for practicing the teachings of the present disclosure includes one or more display devices 10, one or more content playback devices 20, one or more servers 30, and a network 40 which is used for establishing communication between the display devices 10, content playback devices 20 and the server 30. Alternately, the display device 10 and content playback device 20 may be integrated into a single unit.

The display device 10 may be a digital photo frame/digital painting frame or any electronic output device for presentation of information in visual format. The display device 10 can be without limitation a LCD/LED/CRT screen, an e-ink, OLED device, a quantum dot, etc. The display device 10 may be of any resolution. In an embodiment, each display device 10 may be placed at a desired angle and/or be of any size/shape/orientation to display the digital content or a part thereof. Exemplary shapes of the display device 10 include without limitation square, rectangular, triangular, rectangle, rhombus, circle, oval, or any regular/irregular shape in for example, 2D/3D or size/aspect ratio (16:9, 4:3, 1:1, etc.). The display device 10 may include mat/mask.

In an embodiment, the display device 10 includes multiple digital content display zones and each content display zone is assigned to display multiple contents at the same time. Alternately, each content display zone is assigned to display a single content at one time. Or, each content display zone is assigned to display same/different digital content in multitude of formations such as but not limited to picture in picture (PIP), side by side, up and down, corners and other ways with no restriction on position and number of such zones.

In an embodiment, the display device 10 plays the contents in a random fashion using either pre-configured settings or ad-hoc content. The ad-hoc content may include content arranged in a random fashion. In an embodiment the display device 10 may switch contents in a synchronized manner.

The display device 10 includes without limitation a communication device 11, input/output controller 13, and sensor array 15. The communication device 11 is used to establish communication between display devices 10, server 30, content playback device 20 and/or third-party servers without limitation weather stations, 3rd party content providers, information systems, internet based radios, content streaming servers, terrestrial radio stations and other broadcasting servers, etc.

The optional input/output controller 13 is used for controlling the information being displayed on the display device 10. The input/output controller 13 can also take external actions based on various inputs which includes but is not limited to switching lighting on/off/dimming up/dimming down, music control internally and on external devices, video control, mood control and other various home automation controls. The optional input ports and devices may be USB ports, SD Card reader, fire-wire ports, lightning ports, serial ports, parallel ports, LAN/WAN port, microphone ports, etc.

The optional sensor array 15 can be used for providing environmental information to the mat/mask of the display device 10. Environmental information is such as but not limited to current temperature, occupancy, camera and current inside lighting conditions.

The content playback device 20 decodes digital content, applies various content effects, and transmits the digital content with the content effects at a pre-defined frame rate, which can be defined by the content in question or overridden manually. The content effects includes without limitation transition effects, filters, masking, cropping, etc. In an embodiment, rather than having a separate display device 10 and content playback device 20, the content playback device 20 may be embedded in the display device 10. In accordance with another variation, a single content playback device 20 may be coupled to multiple display devices 10.

The content playback device 20 includes playback software 100, microprocessor 22, and memory 24. The content playback device 20 may also have an optional sensor array 15, display driver, an optional USB interface module, an optional wireless module, an I/O module, an optional audio driver module, an optional audio input device/microphone, and a power module not shown in the figure.

In one of the embodiments, the optional sensor array 15 may be a part of both the display device 10 and the content playback device 20 or may be on any one of the device.

The playback software 100 is designed to prepare and direct digital content to the display device 10. The playback software 100 performs various tasks such as playing playlists, cropping digital contents received from the server 30, decoding digital contents received from the server 30, adding transition effects, applying filters, performing internal photo masking based on pre-programmed settings or real-time parameters, changing playlist sent by the server 30 by using triggers or voice commands or manual scheduling etc. To perform these tasks, the playback software 100 uses various modules which would be discussed subsequently.

The microprocessor 22 controls and collaborates the functioning of all the modules and fetches the required data from the memory 24.

The memory 24 receives and stores all the downloaded digital contents received from the server 30 or from external streaming sources such as third party sources or from any of the available communications channels such as a USB interface, DVD player, Blu-ray player, webcam, etc. The USB interface can be configured to receive a USB based memory module and reads the USB based memory module for any available content. Further, it extracts the content into the internal memory of the content playback device 20. The memory 24 may also provide a secure storage of DRM protected digital content. The digital content stored may be later displayed via the display device 10 as per the pre-defined instructions. The instructions include the transition effects, filters and other such instruction which define how and when the digital content must be displayed.

In an embodiment photovoltaic cells may be mounted on the content playback device 20 or on external frame attached to the display device 10. The photovoltaic cells generate electric power by using solar energy. The photovoltaic cells may be made up of monocrystalline, polycrystalline, amorphous silicon cell, hybrid, printable etc. These photovoltaic cells may be used to charge the internal batteries of the devices which may be made up of Lion/Li-polymer or any other materiel known in the art. Thus, the photovoltaic cell may act as a secondary power source to provide prolonged batter life and save the underlying batter from failure. The system is intelligent and fall back to secondary power source when the reserves of stored energy falls below a threshold.

The server 30 may be a heterogeneous server or any other kind of server known in the art and includes playback server software 300, a processor 32 and one or more databases 34. The playback server software 300 is designed to control, prepare and direct the content playback devices to display the digital contents. The playback server software 300 performs many tasks such as creating playlists, creating stage designs, controlling live playback of digital contents, controlling remotely the display devices on art wall, cropping digital contents, adding transition effects, adding filters, photo masking, pushing contents onto content playback device 20, controlling playlist by single click, controlling the content playback device 20 configurations etc. Further details on tasks are provided subsequently.

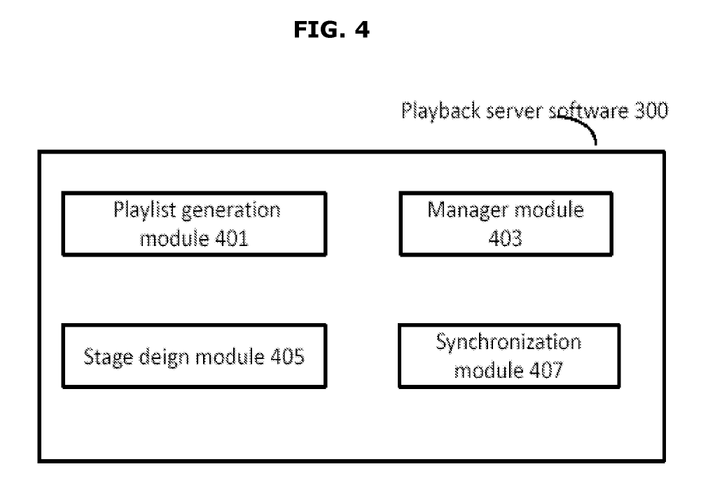

To perform these tasks, the playback server software 300 has various modules. These modules would be discussed in FIG. 4. In one embodiment, the processor 32 controls and collaborates the functioning of all the modules and fetches the required data from the database 34.

The database 34 may be a heterogeneous database or any other kind of database known in the art and may store metadata information related to playlists, content playback device configuration details, digital contents, etc. The metadata may contain playlist name, playlist contents, playlist order, transition on playlist, playlist group, triggers, content playback device id, display device id etc. The other information which can be stored in the database 34 may be configuration details of each content playback device 20. The database 34 may also store digital contents which may be displayed by the display device 10.

The network 40 is used for establishing communication between the display device 10, content playback device 20 and the server 30. The network 40 may be a global area network (GAN), such as the Internet, a wide area network (WAN), a local area network (LAN), or any other type of network or combination of networks. The communication medium may provide for wireline, wireless, or a combination of wireline and wireless communication between devices in the network. In some embodiments of the invention the communication medium described herein may be a cloud computing network.

FIG. 1b shows an exemplary implementation of the system of FIG. 1a. FIG. 1b shows three display devices 101, 102 and 103 arranged in a haphazard fashion on a display wall. Here in FIG. 1b as depicted, the display devices 101, 102 and 103 are digital photo frames. Each of the display devices 101, 102 and 103 are attached either externally or internally with content playback devices 105. Further, a server 107 manages and controls all the display devices and content playback devices via a network 109. Each display device may be provided with an external detachable frame 111 and an internal changeable mat/mask.

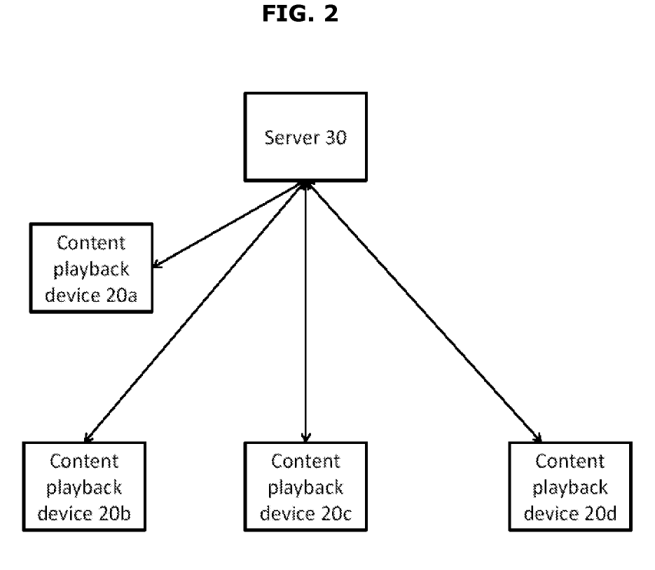

FIG. 2 depicts an exemplary architecture illustrating connections between multiple content playback devices 20 and server 30. In this depiction, four content playback devices 20 are configured to form a single playback group. Typically, a user configures x number of content playback devices as a playback group and updates the server with the required information. The information includes IP address, communication port, unique identifier of current player, etc. A playback group may be defined as a virtual group of one or more master content playback devices and one or more slave content playback devices. In this exemplary architecture, the content playback device 20a is configured as a master while the remaining content playback devices 20(b-d) are configured as slaves. It may be noted that the master may be any content playback device 20(a-d) in the playback group and can be randomly selected by the server 30 or a user.

The digital content may be published or played back by the master and/or slave content playback devices (with or without synchronization) as per user's requirement.

In one embodiment, a sub-module controller is coupled to the master content playback device 20a for switching between contents and playlists remotely.

The master content playback device 20a monitors and controls slave content playback devices 20(b-d). The master content playback device 20a also monitors the slave content playback device for malfunction. The master content playback device 20a further maintains synchronization of the slaves content playback devices 20(b-d) in the playback group.

The slave content playback devices 20(b-d) play the digital content and work in synchronization with other slave content playback devices 20(b-d) in the playback group with the help from the master content playback device 20a. The slave content playback devices 20(b-d) have the ability to become a master content playback device in case the master content playback device malfunctions or is requested by the manager.

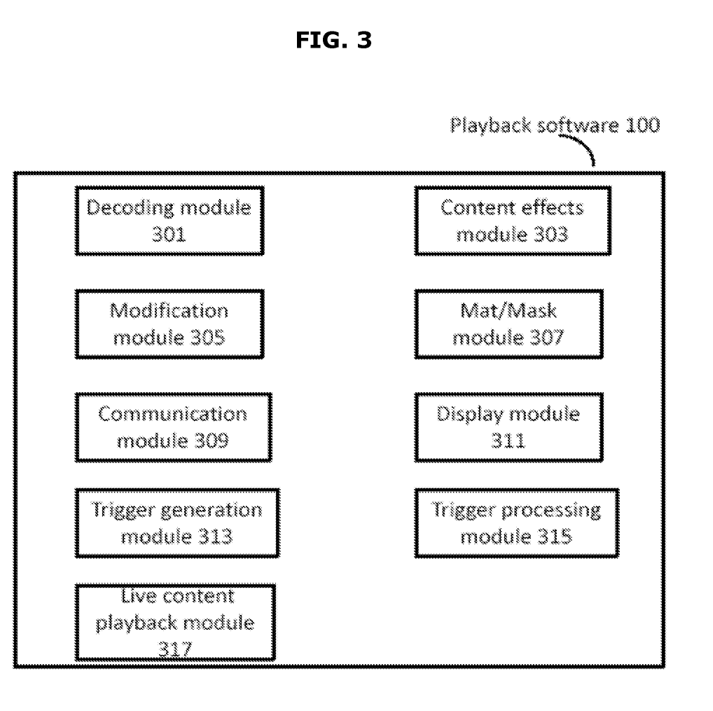

Now moving forward, FIG. 3 illustrates a modular block diagram of the playback software 100 of a content playback device. The playback software 100 prepares and directs digital content to the display device 10. The playback software 100 may include a decoding module 301, a content effects module 303, a modification module 305, a mask/mat module 307, a communication module 309, a display module 311, a trigger generation module 313, trigger processing module 315 and/or alive content playback module 317. Other modules as required may be added and disclosure is not restricted to the modules mentioned above. A detailed description of each is as follows:

The decoding module 301 reads the digital content from its local memory once the digital content is received from the server 30 or an external device. It then decodes the digital content by using any of standard decoding techniques.

The content effects module 303 applies one or more content effects for example, transition effects, filters and/or cropping by using pre-programmed/pre-configured settings or dynamically auto calculated settings based on various factors such as photo color, background, ambient temperature, lighting, etc. while displaying the relevant digital content on one or more display devices 10. The content effects may comprise scaling the content on the display device 10 and includes filling the display device 10 irrespective of the aspect ratio or filling the display device 10 keeping an aspect ratio fixed. The transition effects may be such as but not limited to dissolve, ripple, 3D boxing, cloth, fade in/out as per users' choice.

In an embodiment, the filters applied may be such as and not limited to sepia tone, vintage, grain effect, pencil sketch, grayscale, canvas, blur, and/or pan-zoom/ken burns effect to change the look of the digital content as per users' choice.

The modification module 305 changes digital contents or playlists using various triggers such as internal triggers (for e.g. outside weather, voice commands etc.) or external triggers (Music/DMX etc.). The external triggers may also include current location of the device which may be identified by using known techniques such as Global Positioning System (GPS), Global Navigation Satellite System (GLONASS), etc. The external triggers may retrieve social information such as birthday, anniversary, festival and occasion dates through the internet, social profiles of the user or through user instructions/voice commands or otherwise pre-entered and based on it display digital contents on the display device 10.

In another embodiment, the modification module 305 enables the content playback device 20 to play digital contents in an order defined by a single or combination playlist. The modification module 305 allows the playlist to dynamically modify its own playback order/sequence based on rules that are either pre-defined or are based on dynamic variables such as triggers or user control. The modification module 305 may also allow switching of playlists based on triggers or user control.

The mask/mat module 307 performs internal photo masking. The mat/masking may be of varied type including but not limited to static, dynamic, digital, electrical or physical and can be of varying sizes and content (single/multiple). The mat area may be physical or virtual. The content for internal mats/masking can also be changed or customized as per pre-defined rules/triggers. The customization of the mat area may be made based on various colors, gradients, images, videos as per user's choice. For example, based on dynamic color correction and changing of digital content, the mat/mask would be changed as per the digital content which is displayed on the display device 10.

The communication module 309 enables the content playback device 20 to establish communication with the server 30. After the communication is established and based on the configuration of the content playback device 20, either the server 30 may push the digital content onto the content playback device 20 or allow the content playback device 20 to pull the digital contents from the server 30. The communication module 309 receives digital content or reference to third party content providers, commands and settings through network 40 from the server 30. Further, the communication module 309 allows sharing of downloaded digital contents amongst the slaves or in between the master and the slaves via the network 40 to reduce the overhead of downloading the same digital contents again from the server 30 or third party content providers.

The display module 311 uses pre-defined settings to allow automatic adjustment of size and resolution of digital contents so that they can fit in the screen size of the display device 10 which may be of varying sizes and resolutions.

The trigger generation module 313, generates various types of triggers such as external triggers and internal triggers for the playlists. Details of the triggers have already been discussed above.

The trigger processing module 315 processes the triggers as per the pre-defined instructions received from the said internal or external triggers and applies the processed triggers on the digital contents or displays the alert triggers etc. as the case may be.

The live content playback module 317 provides an interface for a user and allows the user to add live capture/streaming/TV tuners links to the playlist. The live content playback module 317 of the content playback device receives live data from the server 30 or 3rd party content provider and allows live streaming of the digital content.

FIG. 4 illustrates exemplary modular block diagram of the playback server software 300 of the server 30. It includes a playlist generation module 401, a manager module 403, a stage design module 405 and a synchronization module 407. A brief description of each is as follows:

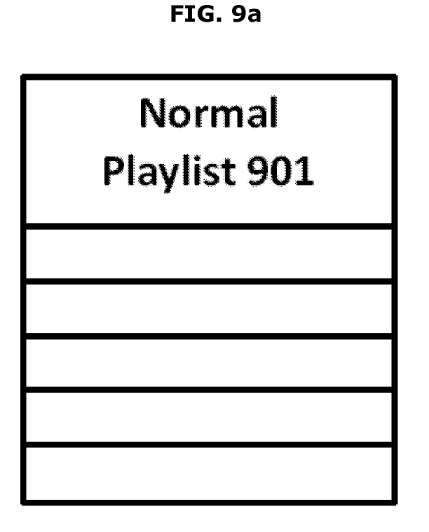

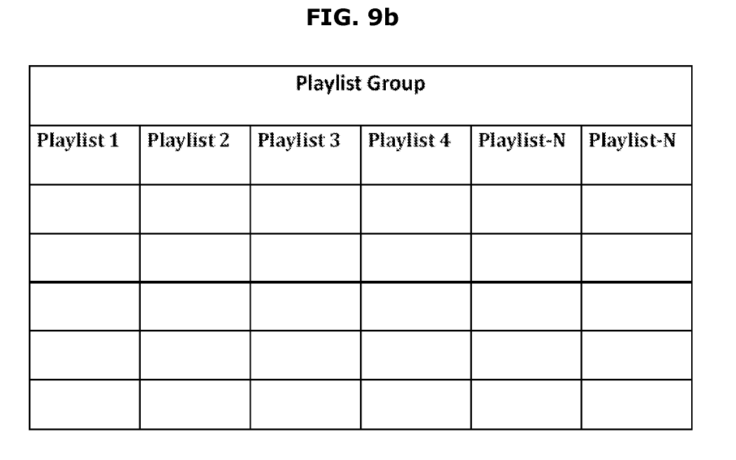

The playlist generation module 401 creates different types of playlists along with play order sequence. The playlists may be maintained in one or more local storages, or on a network or by a third-part content provider. The playlists include encoded instructions or triggers relating to one or more of playback count, geographical position, time of a day, day of a month, temperature, an input from an automation system, average calls attended per person, third-party data, and/or third-party devices that affect the normal flow of content playback. The detailed structure of playlist generated by the playlist generation module 401 is discussed subsequently in FIGS. 9a and 9b.

The manager module 403 allows a user to define a playback order, playlist order, triggers, see past running digital content logs or current content playback devices, system status and player health status, currently running digital content, and/or controls various aspects such as filters or transition effects. The manager module 403 also enables a user to create/modify/delete various visual aspects of the display device 10 such as mat/mask parameters (width, color, image can also be used for this). The manager module 403 also provides the capability to crop the digital content in order to remove gutter spaces between the display devices 10 so that the gallery wall looks like a homogeneous image.

The manager module 403 provides an interface to the user so that the user may use a single image to display by stretching it across multiple/all display devices 10 or in other case the already cropped/broken/part-image is sent to the display devices 10 where the part-image is displayed. The user can also use the manager module 403 to command the display devices 10 to display the digital content in either synchronized fashion or otherwise. The manager module 403 may also control the playlists published onto display devices 10 remotely. Further, the manager module 403 allows switching between digital contents and playlists remotely via network 40 based upon user's requirements.

In another embodiment, the manager module 403, searches for two or more content playback devices on a network and assigns one of the content playback devices in the playback group as a master content playback device and the remaining as slave content playback devices.

The stage design module 405 creates a layout of the arrangement of the content playback devices within the collage to define and quantify the integral properties of the collage. The stage design module 405, configures the stage area and creates a display wall comprising of display devices 10 having different sizes, resolutions and orientation. The stage design module 405 allows the display device 10 to display digital contents in its entirety or only a part of digital contents as per their respective position in the gallery wall and also by other dynamic factors such as internal mat, PIP etc. The stage design module 405 provides layout of the stage by matching the physical location/orientation/angle/size of the display devices 10 within the collage by modifying parameters such as but not limited to internal spacing of frames, outer bezel, angle/rotation/orientation, dimensions (length and width), shape and overlapping area of display device 10. The stage design module 405 allows the display device 10 to scale the digital contents in the display area in a number of ways for example but not limited to filling the screen irrespective of the aspect ratio, filling of the screen keeping aspect ratio fixed, displaying complete image or cropping a part of it based on users' input/requirements. The stage design module 405 allows the display devices 10 of varying size and varying resolution to be independent of resolution of the digital contents. Further, the stage design module allows digital contents displayed are independent of the orientation of the display devices 10. The stage design module 405 allows live stage design control. The digital content displayed as per complete stage design can be auto adjusted with relative effects and correction in the resolution. The disclosure also provides an option of visual scaling of content, i.e. the same content may be displayed on different display devices 10 having different resolutions/sizes by using one of the built-in algorithms.

The synchronization module 407 assigns one or more playlists of the contents to each content playback device in the playback group. The synchronization module 407 provides synchronization between one or more master and the slave content playback devices in the playback group. The synchronization module 407 broadcasts messages to all the masters and slaves in all the playback groups. All the masters and slaves in each playback group send active status response to the synchronization module 407. This process continues from time to time so that the synchronization module 407 may check the availability of all the masters and slaves in all the playback groups to maintain synchronization with each other. Thus, the synchronization module 407 controls various playback group, masters and slaves. The details of synchronization process will be discussed below.

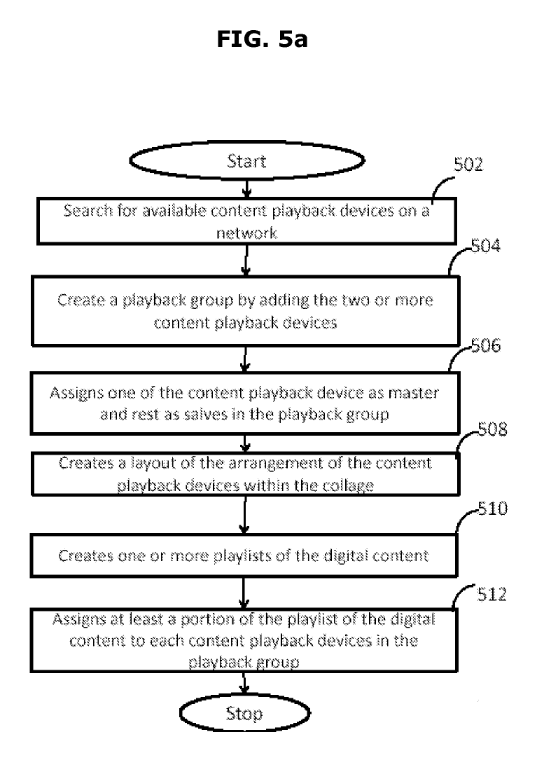

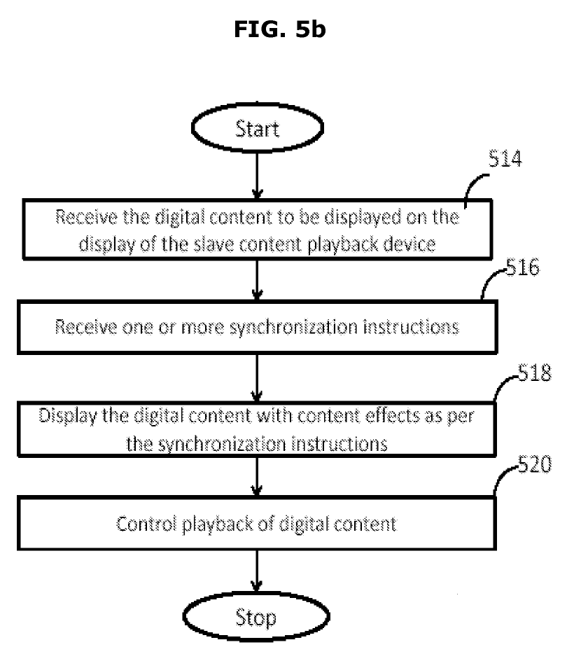

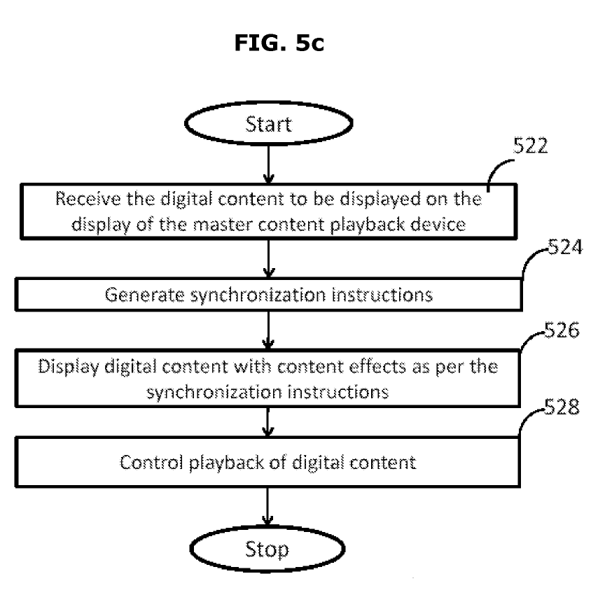

FIG. 5a illustrates a flow diagram depicting steps for preparing a playlist of digital contents to be displayed as a collage on the display devices.

At step 502, the manager module 403 searches for available content playback devices on the network. For this, the manager module 403 broadcasts identification messages to all the content playback devices on the network to check the available content playback devices (CPD). The active content playback devices acknowledge their participation for displaying synchronized collage of digital content by sending their active status back to the server via the network.

At step 504, the manger module 403 maintains one or more playback groups and adds the content playback devices (CPDs) identified in step 502 in the playback groups. In an embodiment, the user may select the CPDs to be added in the playback group via an interface of the playback software 100.

At step 506, the manager module 403 assigns one of the content playback devices in the playback group as a master content playback device. The remaining content playback devices in the playback group are referred as slave content playback devices. Alternately, the user may specify the master and slave content playback devices via the interface.

At step 508, the stage design module 405 creates a layout of the arrangement of the content playback devices which is to be replicated as a collage via the display devices 10. For this, the user provides the inputs about the display devices like resolution, size, angular placement, etc. of the display devices.

At step 510, the playlist generation module 401 creates one or more playlists of the digital content. The user selects one or more digital contents via the interface and stores the same on the server. Further, the user via the interface selects the content effects such as transition effects, filters and/or cropping to be applied on the digital content. The user may specify different content effect to different digital content or same content effect to different digital content. The selected digital content/playlist and the content effects are encoded by using standard encoding techniques such as and not limited to H265, H264, H263, WMV, mpg, DivX etc.

At step 512, the synchronization module 407 assigns at least a portion of the one or more playlists of the digital content to each content playback devices of the playback group in the layout of step 508. In an embodiment, the synchronization module 407 transmits digital content or DRM protected content to the respective content playback device along with the content effects in encrypted form. The transmitted digital content is stored in the content playback device.

In another embodiment, the transmitted DRM protected content may be securely stored in the content playback device.

In another of the embodiment FIG. 5d illustrates a flow diagram depicting steps for displaying a collage of synchronized digital contents at a slave content playback device.

At step 514, the slave content playback device receives the digital content which is to be displayed on the display of the slave content playback device. For example, the slave content playback device receives at least a portion of one or more playlists of the digital content which is to be displayed on its display. The received content also includes the content effects which are to be applied on the digital content. In an embodiment, if the received content is encrypted, the slave content playback device decrypts the received content.

At step 516, the slave content playback device receives synchronization instructions from the master content playback device in the playback group. The synchronization instructions are received in a continuous fashion from the master content playback device on the network.

At step 518, the slave content playback device displays the digital content by applying the content effects as per the received playlist and synchronization instructions. The content effects may be dynamically modifiable filters or masks or cropping or transition effects or scaling. The playback may be adjusted to ensure proper synchronization of the digital content.

Optionally, at step 520, the slave content playback device controls the display of the digital content on receipt of an external trigger or an instruction other than the synchronization instruction.

In another of the embodiment FIG. 5c illustrates a flow diagram depicting steps for displaying a collage of synchronized digital contents at the master content playback device.

At step 522, the master content playback device receives the digital content which is to be displayed on the display of the master content playback device. For example, the master content playback device receives at least a portion of one or more playlists of the digital content which is to be displayed on its display. The received content also includes the content effects which are to be applied on the digital content. In an embodiment, if the received content is encrypted, the master content playback device decrypts the received content.

At step 524, the master content playback device generates one or more synchronization instructions to be associated with the digital content while the digital content is being displayed in a synchronized manner on the display.

At step 526, the master content playback device displays the digital content by applying the content effects as per the received playlist and the synchronization instructions. The content effects may be dynamically modifiable filters or masks or cropping or transition effects or scaling.

Optionally, at step 528, the master content playback device controls the display of the digital content on receipt of an external trigger or an instruction other than the synchronization instruction.

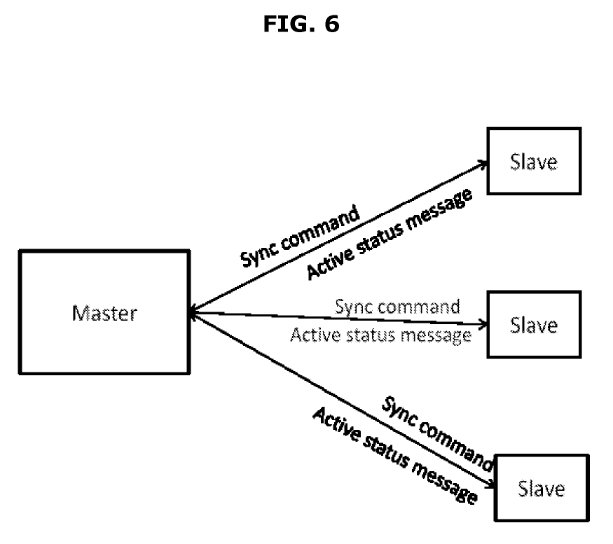

FIG. 6 represents the system diagram illustrating the master broadcasting sync commands/signals for establishing synchronization between master and one or more slaves. Here, the master broadcasts one or more synchronization instructions over the network 40 after defined time intervals to one or more slave content playback devices in the same playback group. The slave content playback devices receive the synchronization instructions and respond to the synchronization instructions which enable the master to determine the status of the slave content playback device and accordingly transmit further commands.

It is to be noted that the content playback devices (master and slave) receive digital content to be played from the server and may optionally save it in its local storage.

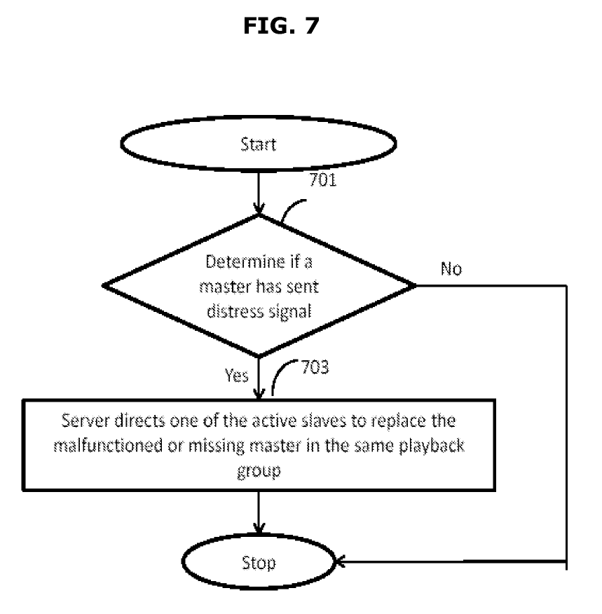

FIG. 7 shows a flow chart in case master malfunctions. At step 701, it is determined if a master content playback device has broadcasted a distress signal due to malfunctioning or does not send any command. If yes, then at step 703, the server directs one of the slave content playback devices to take the position of the missing master. If no, then the process ends and is repeated after a predefined time interval.

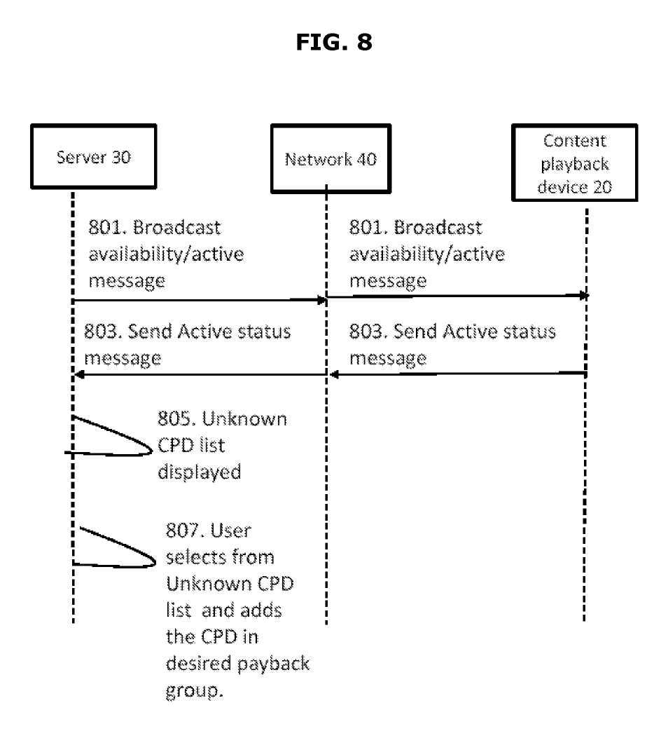

FIG. 8 depicts a time sequence diagram illustrating the availability of content playback devices. At step 801, the server 30 broadcast a message on the network 40. At step 803 all the active content playback devices (CPD) acknowledge their participation for displaying synchronized collage of digital contents by sending their active status back to the server 30 via network 40. At step 805, an unknown CPD list is displayed on a server interface. The unknown CPD list contains all the content playback devices which are not assigned to any playback group. At step 807, a user may select from the unknown CPD list content playback devices that the user wishes to add to a desired playback group. This process is repeated after predefined intervals, say 30 mins.

In one of the embodiments FIG. 9 a shows an exemplary playlist. For organizing digital contents, the playlist may be a normal playlist or a smart playlist. The normal playlist 901 as shown in the FIG. 9 a represents a playlist in which the digital contents may be added in any desired order to be played. Further a normal playlist can be made as a smart playlist. In a normal playlist, content is played one after another sequentially but in smart playlist triggers may be defined that can make the playlist jump to the desired content and play it seamlessly. Some examples of the triggers are given below but are not limited to these:

A GOTO statement may be used in the playlist and when the playlist reaches a GOTO statement it jumps to the desired number in the playlist from where the digital contents may be played.

Triggers may be added for a particular time of day to play a particular digital content.

GPS based triggers may be added in the playlist wherein the digital content may be played based on the location data contained in the metadata of the content. This allows synchronization of the digital content across the content playback devices as per the GPS location where the photo/video was taken.

Temperature based triggers may be added to play the digital content related to the current temperature data received from an attached sensor or from 3rd party data providers. For example, if the temperature is high, content tagged with hot weather taken/created on days with same conditions may be selected from historical weather data for display. Also background or mask/mat color may be changed to depict high temperature, based on pre-defined rules.

Based on occasions on a particular date, triggers may be added to play pre-published digital content. The system may be configured to play content tagged for particular date. For example the contents based on “this day in previous years” or “today's festival in previous years” may be displayed if they are tagged date wise.

Weather based triggers may be added to play content based on current weather conditions, where-in if required, user can choose to display the content tagged with keywords related to weather conditions such as, rainy, sunny, overcast etc.

In one embodiment of the present invention, content playback devices randomly plays available digital content based on orientation of attached display device 10. Further, the plurality of the display devices can also be configured to display same digital content by applying different filter, thereby giving every device a unique look and feel.

FIG. 9b shows the structure of playlist group. The playlist group comprises of a playlist inside a playlist which may be assigned to individual slaves within a playback group. For example the playlist group 1102 consists of playlist 1, playlist 2, playlist 3, playlist 4 . . . playlist N.

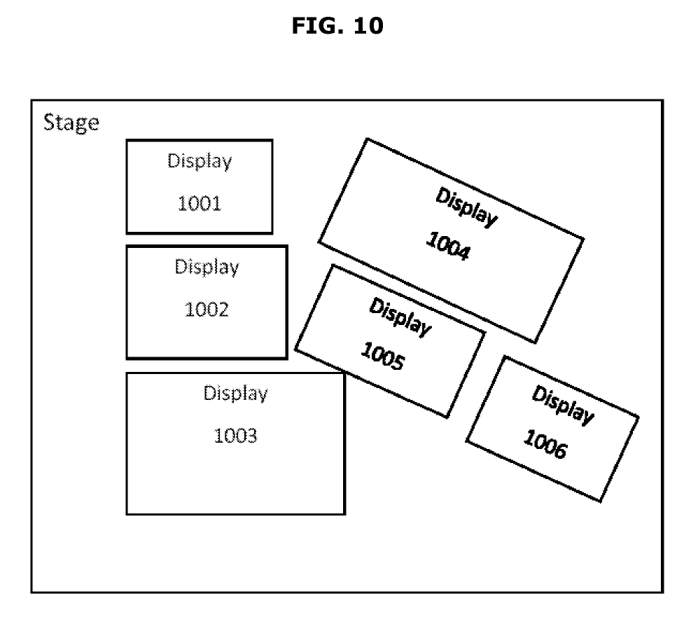

In one of the embodiment FIG. 10 shows a stage which may be configured to comprise of various display devices. The display devices such as 1001, 1002, 1003, 1004, 1005 and 1006 may be of varying resolutions which displays synchronized collage of digital contents. The server 30 allows the user to use an interface for configuring the stage area and create a display wall comprising the display devices with any orientation or size.

In an alternate embodiment the present invention provides a synchronized collage of display device 10 with external detachable outer frame (not shown in figures). The detachable frames may be made of material including but not limited to wood, steel, wrought iron etc. The frames can be attached and detached freely including but not limited to magnetic attraction, clips, hook and loop fasteners, etc.

In another embodiment of the present invention, the content playback device 20 allows emergency alerts to be displayed on the display device 10; wherein emergency messages/hazard information can override the current displayed content. These emergency messages can be manually transmitted from the server 30, or can be linked to third party sources or through triggers.

In other embodiment of the present invention, display device 10 can be interactive as well as equipped with biometric sensors and other security protocols which can be used to protect device from unauthorized access.

In another embodiment the display device 10 has full disk/card/storage encryption support for safeguarding the digital content. Also, the communication between the server 30, content playback device 20 and the display device 10 is encrypted by using standard encryption techniques over the network 40.

With the above embodiments in mind, it should be understood that the embodiments might employ various computer-implemented operations involving data stored in computer systems. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a computer readable medium. The computer readable medium is any data storage device that can store data, which can be thereafter read by a computer system. Examples of the computer readable medium include solid state drives, hard drives, SD cards, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Also, that various presently unforeseen or unanticipated alternatives, modifications, variations or improvements therein may be subsequently made by those skilled in the art which are also intended to be encompassed by the following claims.

1. A system for displaying a collage of content, the system comprising:
a network;
a plurality of displays displaying same/different content or a part thereof;
a master content playback device generates synchronization instructions for content display; and
a plurality of slave content playback devices communicating with the master content playback device via the network, each slave content playback device is paired with a respective display, each slave content playback device applies content effects to the content;
wherein the master content playback device transmits the synchronization instructions to the slave content playback devices to playback the content with the content effects on the respective display in a synchronized manner.

2. The system of claim 1, wherein the master content playback device is coupled to a display of the plurality of displays.

3. The system of claim 1, wherein the master content playback device displays the content with content effects.

4. The system of claim 1, wherein the plurality of displays is of same or varying size, resolution, and shape.

5. The system of claim 1, wherein the plurality of displays is placed at same or varying angles/orientation.

6. The system of claim 1 wherein the plurality of displays comprises detachable frames.

7. The system of claim 1, wherein the plurality of displays include a mat area capable of being customized with one or more colors, gradients, images, and/or videos.

8. The system of claim 7, wherein the mat area is physical or virtual.

9. The system of claim 1, wherein one or more displays of the plurality of displays include multiple content display zones, each content display zone being assigned to display multiple content at the same time.

10-11. (canceled)

12. The system of claim 1, wherein the plurality of displays play the content in a random fashion using either pre-configured settings or ad-hoc content, the ad-hoc content includes content arranged in a random fashion.

13. The system of claim 1, wherein the plurality of displays switch contents in a synchronized manner.

14. The system of claim 1, wherein the master content playback device monitors the slave content playback devices for malfunction.

15. The system of claim 1, wherein one of the slave content playback devices becomes a master content playback device if the master content playback device malfunctions.

16. The system of claim 1, wherein the master content playback device and/or slave content playback devices share the content with each other via the network to reduce the overhead of downloading the same content again from a third party content provider.

17. The system of claim 1, wherein the content effects comprises one or more dynamically modifiable filters including sepia tone, grain effect, pencil sketch, grayscale, canvas, blur, pan-zoom or ken burns effect.

18. The system of claim 1, wherein the content effects comprises masking, and/or cropping.

19. The system of claim 1, wherein the content effects comprise transition effects including dissolve, ripple, three-dimensional boxing, cloth, or fade in/out effect.

20. The system of claim 1, wherein the content effects comprises scaling the content on at least one display including filling the display irrespective of the aspect ratio, filling the display keeping an aspect ratio fixed, displaying complete content or cropping a part of the content.

21. The system of claim 1, further comprising a sub-module controller coupled to the master content playback device which can switch between content and playlists remotely.

22. The system of claim 1, wherein the content includes photos, videos, audios, texts, really simple syndication content, camera input, streaming content, live data, and machine captures.

23. (canceled)

24. A system for creating a collage of synchronized content, the system comprising:
a manager module for searching for two or more content playback devices on a network, maintaining a playback group comprising of the two or more content playback devices and assigning one of the content playback devices in the playback group as a master content playback device and the remaining as slave content playback devices;
a stage design module for creating a layout of the arrangement of the content playback devices within the collage to define and quantify the integral properties of the collage;
a playlist generation module for creating one or more playlists of the content; and
a synchronization module for assigning at least a portion of the one or more playlists of the content to each content playback device in the playback group.

25. The system of claim 24 further comprises a storage for securely storing at least a portion of the one or more playlist of the digital rights management protected content.

26. A method for creating a collage of synchronized content, the method comprising:
searching for two or more content playback devices on a network;
maintaining a playback group comprising of the two or more content playback devices;
assigning one of the content playback devices in the playback group as a master content playback device and the remaining as slave content playback devices;
creating a layout of the arrangement of the content playback devices within the collage to define and quantify the integral properties of the collage;
creating one or more playlists of the content; and
assigning at least a portion of the one or more playlists of the content to each content playback device in the playback group.

27. The method of claim 26, further comprising maintaining the playlists on one or more of a local storage, the network or a third-party content provider.

28. The method of claim 26, wherein the creating the one or more playlists includes encoding instructions or triggers relating to one or more of playback count, geographical position, time of a day, day of a month, temperature, input from automation systems, average calls attended per person, third-party data, and/or third-party devices that affect the normal flow of content playback.

29. The method of claim 26, further comprising at least one of controlling the playback group, controlling content playback device configuration, creating a stage design, or controlling live playback of content.

30. The method of claim 26, wherein the creating the layout includes matching a physical location/orientation/angle/size of a display within the collage by modifying parameters, the parameters including one or more of internal spacing of frames, outer bezel, angle, rotation, orientation, dimensions, shape and/or overlapping area of the display.

31-38. (canceled)

39. A method of displaying a collage of synchronized content, the method comprising:
decoding a content to be displayed on a display of a master content playback device;
receiving at least a portion of one or more playlists of the content;
generating one or more synchronization instructions to be associated with the content while the content is being displayed in a synchronized manner on the display;
displaying the decoded content with content effect as per the received playlist and synchronization instructions; and
controlling playback of the content with the content effect on the display of the slave content playback device.

40. The method of claim 39, further comprising broadcasting the one or more synchronization instructions through a network to one or more slave content playback devices.

41-44. (canceled)

45. A system for displaying a collage of contents, the system comprising:
a plurality of displays attached to one or more content playback devices for displaying same/different contents;
an external frame attached to each display;
a secondary power source mounted on the external frame or attached to the content playback device to provide charge when reserves of stored energy falls below a threshold.

46-47. (canceled)
